(19) United States
(12) Patent Application Publication
(10) Pub. No.: US 2019/0196499 A1
(43) Pub. Date: Jun. 27, 2019

(54) SYSTEM AND METHOD FOR PROVIDING OVERHEAD CAMERA-BASED PRECISION LOCALIZATION FOR INTELLIGENT VEHICLES

(71) Applicant: Samsung Electronics Co., Ltd., Suwon-si (KR)

(72) Inventors: Brian Paden, San Jose, CA (US); Gerard D. Smits, Los Gatos, CA (US); John B. Ricks, Fremont, CA (US)

(21) Appl. No.: 16/231,834

(22) Filed: Dec. 24, 2018

Related U.S. Application Data
(60) Provisional application No. 62/610,495, filed on Dec. 26, 2017.

(51) Int. Cl. G05D 1/02; G08G 1/01; G08G 1/017; G05D 1/00; G06T 7/70; G01S 5/00

(52) U.S. Cl. CPC G05D 1/0285; G08G 1/0116; G08G 1/0175; G06T 2207/30252; G06T 7/70; G01S 5/0054; G05D 2201/0213; G05D 1/0088

(57) ABSTRACT

Provided is a system for providing precision localization for intelligent vehicles, the system including a sensor facing downward to capture information corresponding to an intelligent vehicle below, and in a field of view of, the sensor, and a transmitter for transmitting the information captured by the sensor to the intelligent vehicle to enable the vehicle to take an action based on the information.

### CROSS-REFERENCE TO RELATED APPLICATION(S)

This patent application claims priority to, and the benefit of, U.S. provisional patent application No. 62/610,495 entitled SYSTEM AND METHOD FOR PROVIDING OVERHEAD CAMERA-BASED PRECISION LOCALIZATION FOR INTELLIGENT VEHICLES, filed on Dec. 26, 2017.

### FIELD

One or more aspects of embodiments of the present disclosure relate generally to intelligent vehicles and autonomous driving technology, and more particularly to a system and method for providing overhead camera-based precision localization for intelligent vehicles, and to infrastructure-to-vehicle communication technology for enabling autonomous driving.

### BACKGROUND

Autonomous vehicles associated with advanced driver-assistance systems (ADAS) often rely on accurate depth/distance measurements for localization. As an example, the depth measurements may be achieved using stereo vision and/or active sensors, such as those found in a light detection and radar (LiDAR) system, which may be relatively expensive and may have relatively high computational requirements despite having low resolution. Accordingly, one of the principal challenges in autonomous driving and ADAS is precise localization of vehicles in a fixed-coordinate frame.

The localization task to be solved by ADAS may be achieved by estimating lateral and longitudinal global coordinates of a vehicle with relatively high accuracy. For navigation purposes, the vehicle may be localized with lane-level accuracy to provide driving instructions to the destination. A suitable accuracy for this may be about 1 meter. For driver assistance features, such as adaptive cruise control and lane following, localization may be accurate enough to determine whether a planned maneuver is legal and safe to execute. A suitable accuracy for this may be about 10 centimeters or better. Thus, ADAS may use onboard sensors, such as forward-facing cameras, to assist in localization operations. However, challenging computer-vision problems may arise in such systems, as depth measurements may be inferred from camera measurements of the forward-facing cameras.

As another example, conventional Global Positioning System (GPS)-based localization may not provide sufficient accuracy or bandwidth for advanced driver-assistance systems, and may often cause issues for navigation of road networks. Although GPS-based localization is occasionally accurate enough for localization, GPS-based localization may fail in bad weather, or may fail when the line-of-sight to GPS satellites is obstructed.

Accordingly, an improved system for providing information for precision localization for intelligent vehicles may be beneficial.

It should be noted that information disclosed in this Background section is only for enhancement of understanding of the embodiments of the present disclosure and may include technical information acquired in the process of achieving the inventive concept. Therefore, it may contain information that does not form prior art.

### SUMMARY

Embodiments described herein provide improvements to intelligent vehicle technology and to autonomous driving technology.

According to one embodiment of the present disclosure, there is provided a system for providing precision localization for intelligent vehicles, the system including a sensor facing downward to capture information corresponding to an intelligent vehicle below, and in a field of view of, the sensor, and a transmitter for transmitting the information captured by the sensor to the intelligent vehicle to enable the vehicle to take an action based on the information.

The sensor may be a camera affixed to a light pole.

The information may be a photographic image or video stream including the intelligent vehicle therein.

The information may indicate position, heading, speed, and acceleration of various objects and/or individuals within the field of view of the sensor.

The transmitter may include at least one GaN narrow-band laser that is configured to have an intensity or wavelength of light thereof modulated to transmit the information to at least one photodiode of the intelligent vehicle, wherein the at least one GaN narrow-band laser is configured to illuminate the field of view of the sensor.

The information transmitted by the transmitter may be configured to be received by a server or substation that is networked to a plurality of transmitters to form a network a plurality of sensors with overlapping fields of view and respectively connected to the plurality of transmitters.

A position of each of the plurality of sensors and a direction of each corresponding field of view may be calibrated to generate a global coordinate system that can be interpreted by the intelligent vehicle.

The sensor may be configured to detect a unique identifier that is attached to the intelligent vehicle, wherein the system is configured to encrypt the information based on the identifier such that the intelligent vehicle can receive and decrypt the transmitted information to the exclusion of others.

The unique identifier may be a QR code.

According to another embodiment of the present disclosure, there is provided a method of providing precision localization for intelligent vehicles, the method including capturing, by a sensor, information corresponding to an intelligent vehicle below, and in a field of view of, the sensor, and transmitting the information to the intelligent vehicle to enable the vehicle to take an action based on the information.

The method may further include affixing the sensor to a light pole, wherein the sensor is a camera, and wherein capturing information corresponding to the intelligent vehicle includes capturing a photographic image or video stream including the intelligent vehicle therein.

The information may indicate position, heading, speed, and acceleration of various objects and/or individuals within the field of view of the sensor.

The method may further include illuminating the field of view of the sensor with at least one GaN narrow-band laser, wherein transmitting the information includes modulating an intensity or wavelength of light of the at least one GaN narrow-band laser to transmit the information to at least one photodiode of the intelligent vehicle.

The method may further include transmitting the information to a server or substation that is networked to a plurality of transmitters to form a network a plurality of sensors with overlapping fields of view and respectively connected to the plurality of transmitters.

The method may further include calibrating a position of each of the plurality of sensors and a direction of each corresponding field of view to generate a global coordinate system that can be interpreted by the intelligent vehicle.

The method may further include detecting, by the sensor, a unique identifier that is attached to the intelligent vehicle, and encrypting the information based on the identifier such that the intelligent vehicle can receive and decrypt the transmitted information to the exclusion of others.

According to yet another embodiment of the present disclosure, there is provided a non-transitory computer readable medium implemented on a system including a sensor facing downward to capture information corresponding to an intelligent vehicle below, and in a field of view of, the sensor, and a transmitter for transmitting the information captured by the sensor to the intelligent vehicle, the non-transitory computer readable medium having computer code that, when executed on a processor, implements a method of providing precision localization for the intelligent vehicle, the method including capturing, by a sensor, information corresponding to an intelligent vehicle below, and in a field of view of, the sensor, and transmitting the information to the intelligent vehicle to enable the vehicle to take an action based on the information.

The instructions, when executed by the processor, may further cause the processor to Illuminate the field of view of the sensor with at least one GaN narrow-band laser, wherein transmitting the information includes modulating an intensity or wavelength of light of the at least one GaN narrow-band laser to transmit the information to at least one photodiode of the intelligent vehicle.

The instructions, when executed by the processor, may further cause the processor to detect, by the sensor, a unique identifier that is attached to the intelligent vehicle, and encrypt the information based on the identifier such that the intelligent vehicle can receive and decrypt the transmitted information to the exclusion of others.

The instructions, when executed by the processor, may further cause the processor to calibrate a position of each of the plurality of sensors and a direction of each corresponding field of view to generate a global coordinate system that can be interpreted by the intelligent vehicle.

Accordingly, the system of embodiments of the present disclosure is able to provide precision localization for intelligent vehicles by capturing and processing spatial information relating to an intelligent vehicle, transmitting the information to the vehicle, and enabling the vehicle to take one or more of several actions based on the transmitted information.

### BRIEF DESCRIPTION OF THE DRAWINGS

These and/or other aspects will become apparent and more readily appreciated from the following description of the embodiments, taken in conjunction with the accompanying drawings, in which:

FIG. 1 illustrates a system capable of overhead sensor-based precision localization for intelligent vehicles, according to an embodiment of the present disclosure;

FIG. 2 illustrates Y and Z axes along a vehicle, according to an embodiment of the present disclosure;

FIG. 3 illustrates X and Y axes along a vehicle, according to an embodiment of the present disclosure; and

FIG. 4 illustrates a calibration vehicle for calibrating a position of an overhead sensor in a global coordinate system, according to one embodiment.

### DETAILED DESCRIPTION

As previously mentioned, conventional ADAS-based and GPS-based localization may fail to provide sufficient accuracy and bandwidth for intelligent or autonomous vehicles. Embodiments of the present disclosure assist vehicles with precise localization.

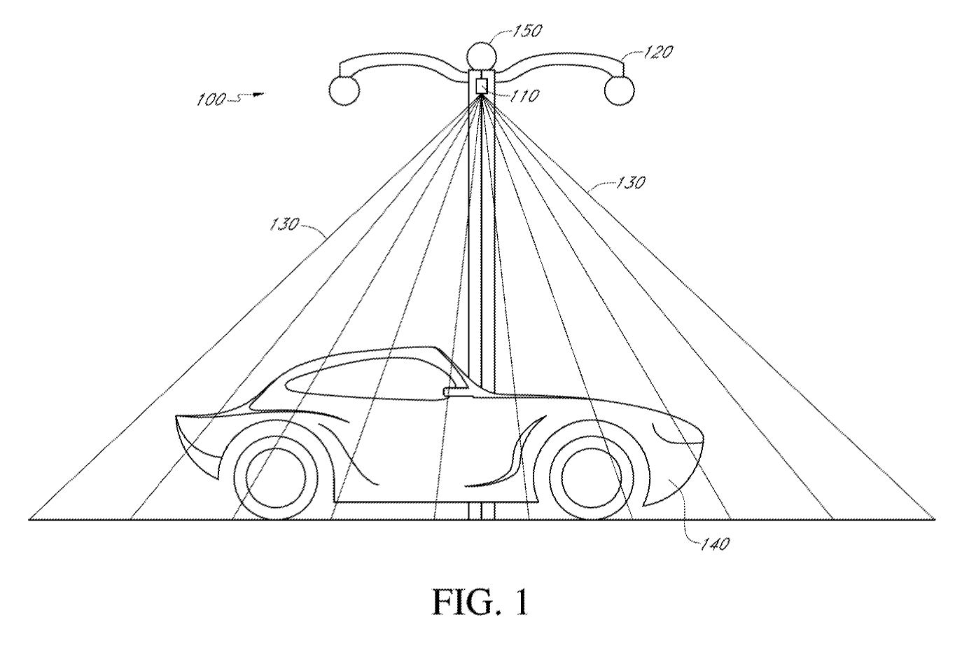

FIG. 1 illustrates a system capable of overhead sensor-based precision localization for intelligent vehicles, according to an embodiment of the present disclosure.

Referring to FIG. 1, a system 100 of the present embodiment includes one or more overhead, downward-facing sensors/image capturing devices fixed to a piece of sufficiently elevated infrastructure. In the present embodiment, the overhead, downward-facing sensor is a camera 110, and the elevated infrastructure to which the camera 110 is fixed is a light pole 120. The camera 110 may be plugged into, or may receive power from, the same source of power for the lamp/lasers that produces the light from the light pole 120.

The system 100 may include a single camera 110, or may include a grid of a plurality of cameras 110 mounted to respective light poles 120 that are spaced apart (e.g., separated by about thirty meters). Accordingly, the system 100 may be a standalone single camera, or may be a network including a string of cameras 110 respectively mounted on a string of consecutive light poles 120.

The camera 110 may be able to capture one or more images within its field of view 130. An image within the field of view 130 of the camera 110 may include the image of one or more vehicles 140. The camera 110 may have an exposure of about one msec, although the present embodiment is not limited thereto.

The system 100 may include a processor for various processing of information captured by the camera 110. Processing by the system 100 may calculate or otherwise determine relevant data and calibration information for assisting operation of the one or more vehicles 140. Such data and calibration information may be calculated by processing the images and data captured by the camera 110 in association with the orientation and position calibration information of the camera 110. Accordingly, the location, direction, and positioning of the vehicle 140 may be obtained.

The camera 110 may be connected to a local wireless transmitter (e.g., a short-range wireless transmitter) 150. Each camera 110 may be connected to a respective local wireless transmitter 150, or, alternatively, multiple cameras 110 may be connected to a single local wireless transmitter 150. The local wireless transmitter 150 may also be fixed to the same infrastructure as the camera 110 (e.g., the light pole 120 in the present embodiment). The local wireless transmitter 150 may wirelessly broadcast images or video captured by the camera 110.

The local wireless transmitter 150 may also wirelessly broadcast relevant data and other calibration information indicating the precise location of the associated camera 110. For example, the local wireless transmitter 150 may transmit information regarding speed (e.g., velocity of the vehicle 140, which may be provided in cm/msec when the camera 110 has an exposure of one msec, and when one pixel of an image captured by the camera 110 corresponds to one cm) of one or more objects or people shown in the images or video captured by the camera 110. That is, the local wireless transmitter 150 may be able to transmit information regarding position, heading, speed, acceleration, etc. of the vehicle 140 and/or of other objects and vehicles in the field of view 130 of the camera(s) 110.

In another embodiment, instead of the local wireless transmitter 150, the system 100 may transmit information to the cars using light (e.g., “Li-Fi”). For example, the system 100 (e.g., the light pole 120) may include a light source, such as one or more lasers. Unlike LEDs, lasers can be modulated at frequencies in the GHz range. The high-speed modulation of the lasers enables the system to quickly collect and disseminate information used by the vehicles receiving the date from the transmitter 150. It should be noted that neither phosphor nor conventional LEDs (including GaN LEDs) can be modulated at GHZ frequencies.

In one embodiment, the lasers may be 2-4 watt side-emitting Blu-ray/blue ray GaN lasers that produce light having wavelengths near about 405 nm. The lasers may be narrowband, and may produce a spectrum of light in a narrow band. Such lasers may be barely luminous below about 1 LM/watt, but may still enable the camera 110 to capture a sufficient amount of information corresponding to various objects and vehicles 140 within its field of view 130. Contrastingly, white phosphor lighting may generate broadband illumination, and conventional LEDs may have luminosity corresponding to around 250 LM/watt.

Accordingly, the system 100 is able to illuminate (e.g., by using flashes or pulses of light) the field of view 130 of the camera 110, and the camera 110 is able to capture ultra-precise units including sharp, single-frequency RAW images. Thereafter, the transmitter 150 is able to transmit the captured images (“as is”) to the car below. Because time can be of the essence in informing the smart vehicle 140, GaN lasers are able to provide substantial improvement to the field of autonomous driving due to their ability to be modulated at a high rate. That is, minimal latency is achieved by using broadband instantaneous, LI-FI-style laser transmission at Gb/sec.

Accordingly, the present embodiment is able to use light to both illuminate (e.g., using flash exposure) and capture imagery corresponding to the field of view 130 of the camera 110 in real-time, and is also able to transmit the RAW pixels image captured by the camera 110 in a previous frame while incurring only one frame of delay by modulating the diode laser, something that might not be achievable using a light-emitting diode.

The light produced by the light source may illuminate the field of view 130 of the camera 110 to allow the camera 110 to effectively capture images or video of the area therebelow. Additionally, the light source may have an intensity or frequency thereof modulated to emit different wavelengths of light, different intensities of light, or differently timed flashes of light. The different wavelengths, intensities, or bursts of light may be perceived by the vehicle 140 (e.g., by a photodiode or light sensor attached to the vehicle 140). Accordingly, the light emitted by the light pole 120 may illuminate the field of view 130, but may also be used to transmit the various information processed by the system 100 to the vehicle 140 corresponding to data associated with images captured by the camera 110.

For full control of the vehicle 140, the vehicle 140 may be a smart vehicle/intelligent vehicle, may have a minimum amount of drive-by-wire capabilities, may include a processor/processing module in the vehicle 140 for controlling the vehicle 140, and may be operated by a human driver that is willing to allow the vehicle 140 to drive without intervention (e.g., a human driver that does not override control instructions provided by the vehicle's module to control operation of the vehicle 140). Accordingly, the system 100 of the present embodiment allows one or more enabled vehicles 140 within a given range, or vicinity, of the camera(s) 110 and local wireless transmitter 150 to subscribe to broadcast messages. The broadcast messages may include control instructions (e.g., breaking, accelerating, and steering) to assist in intelligent or autonomous driving of the intelligent vehicle 140. For example, an advanced driver assistance system (ADAS) of the vehicle 140 may connect to the local wireless transmitter 150 to subscribe to an image stream/video stream including images captured by the camera 110. Thereafter, the vehicle 140 may identify itself within one or more images of the image stream, and may decide to take some action based on an analysis of the images.

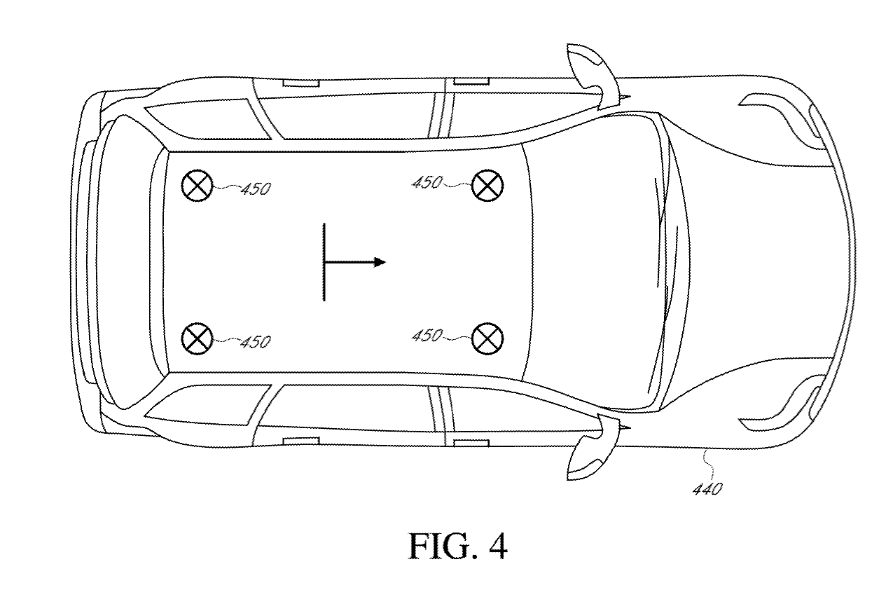

Further, the camera 110 may be calibrated within a global coordinate system, as described below with reference to FIG. 4, so that the vehicle 140 may also obtain precise global localization from calibration data contained in the broadcast messages. The camera 110 may have its orientation and position calibrated with a sufficient degree of precision to enable accurate operation of the system 100. That is, the system 100 may be calibrated such that the camera 110 is aware of its precise location in a global coordinate system, and corresponding information may be transmitted to the intelligent vehicle 140. Accordingly, the vehicle 140 my localize itself within the one or more images and in the physical world due to the overhead position of the calibrated camera 110, which provides a transverse measurement of the location of the vehicles 140 with respect to a global coordinate system, thereby enabling high accuracy localization of the vehicle 140 within its environment.

Accordingly, the system 100 may provide highly accurate localization to a vehicle 140 in its vicinity by having an overhead view that indicates the exact positions of various vehicles and other objects (e.g., pedestrians) to the vehicle 140, and may use the indicated positions to influence or otherwise control actions and movement of the vehicle 140. The system 100 is therefore able to effectively provide a digital mirror in the sky, and may be used to accelerate traffic mobility, may otherwise improve traffic conditions, and may assist in increasing the number of cars per hour/per lane, thereby effectively decreasing gridlock. For example, during heavy weather (e.g., extreme rain or snow), the camera 110 may be accurately aware of its location (including the light pole 120), and may therefore be accurately aware of the location of the objects within its field of view 130, and can thereby ensure that passing vehicles are also made aware of its location and their location in relation thereto.

To summarize, the system 100 of the present embodiment includes a calibrated sensor (e.g., a camera 110) located on a fixed elevated structure (e.g., a light pole 120) for broadcasting (e.g., with a local wireless transmitter 150 or with a light-emitting diode of the light pole 120) to the vehicle 140 information (e.g., a downward facing image included within the camera's 110 field of view 130, along with other calibration and localization data).

It may be noted that the installation of numerous sensors into an intelligent city infrastructure may potentially infringe on the privacy of users of the road network. Safeguards for maintaining user privacy associated with the data transmitted by the system 100 may be implemented in embodiments of the present disclosure. According to an embodiment, the vehicle 140 in the field of view 130 of the camera 110 may include a unique identifying feature to help ensure privacy. For example, a unique quick response (QR) code may be placed on the roof, hood, or tail of the vehicle 140, and may be used to enable the system 100 to easily identify different vehicles within an image captured by the camera 110. In other embodiments, different methods for uniquely identifying the vehicle 140 may be used (e.g., an RFID identification system, or some other transponder).

As previously mentioned, the local wireless transmitter 150 may broadcast images and other localization data to all vehicles 140 within range (e.g., all vehicles below, and within the field of view 130 of, the overhead smart camera 110). Because each vehicle 140 may have a unique identifier, such as a QR code, the overhead smart camera 110 may capture an image of the QR code of the vehicle 140 in the field of view 130 such that the QR code is detected by the system 100. Thus, the system 100 is able to distinguish between two different vehicles by using the QR codes, may encrypt any image or data that is broadcast (e.g., by using the QR code), and may transmit encrypted messages intended for respective vehicles according to the detected QR codes.

For example, the local wireless transmitter 150 may broadcast an encrypted image of the vehicle 140 driving below the overhead smart camera 110 to only that vehicle 140 by hashing a broadcast message using the corresponding QR code. Thereafter, the vehicle 140 may decrypt the received data, and may perform analysis thereon. Accordingly, the system 100 may indicate to only the corresponding vehicle 140 certain aspects of the vehicle's environment as seen from the bird's-eye view of the camera 110 (e.g., everything immediately in front of the vehicle 140 and immediately behind the vehicle 140 that was in the field of view 130 of the camera 110 at the time the image is captured by the camera 110), and may do so without transmitting the information to other vehicles. Accordingly, the vehicle 140 with the corresponding QR code is able to receive encrypted data relating to its surroundings in accordance with the bird's-eye view captured by the camera 110 to enable its onboard localization.

Vehicles not having the corresponding QR code (or not having any QR code) may not decipher the data provided from the system 100 to the vehicle 140 because of the encryption of the encrypted image. However, the system 100 is still able to update these other vehicles such that the vehicles may know that another vehicle is in front of or behind them. That is, the system 100 may provide other relevant information to vehicles other than the vehicle 140 having the QR code without providing a copy of the encrypted image sent to the vehicle 140 having the QR code.

It should further be noted that the system 100 of the present embodiment may include a non-standardized interface, and may use one-way communication to more easily enable integration into localization modules of collaborators (e.g., an onboard module of the vehicle 140). Because the interface may be a standard camera image, users of the data can place any chosen identifying feature on their vehicle that can be recognized by the vehicle's onboard module.

To summarize, according to the present embodiment, the overhead smart camera 110 may read a QR code, which may be located on the vehicle 140 (e.g., on the roof of the vehicle 140). The system 100 may then encrypt the image captured by the camera 110 per the QR code. The local wireless transmitter 150 may then transmit an encrypted image to the vehicle 140 with the QR code, or may transmit a raw image with an identifier (ID). The vehicle 140 may then decrypt the encrypted image, as the vehicle 140 may be aware of its QR code. Accordingly, a secure connection between the vehicle 140 and the system 100 may be achieved.

That is, in the interest of privacy, the system 100 may further encrypt what the local wireless transmitter 150 broadcasts to various individual vehicles, and may delete the broadcast information shortly after it is transmitted. In the interest of privacy, an array of cameras 110 may encrypt to a random hash that which is broadcast by respective local wireless transmitters 150 connected thereto, but may also encrypt messages specifically for a particular vehicle 140 when it sees a QR code thereon so that only the QR-coded vehicle 140 is able to decrypt the transmitted image.

According to another embodiment, the system 100 may include a server for coordinating multiple systems 100. That is, if a smart camera 110 is installed on each light pole 120 in a given area (e.g., in a city block), and if a server or substation is located in the area (e.g., on a corner of the city block, or at every other intersection), then when an autonomous vehicle 140 turns onto a busy street from the highway, a warning light on the dash board of the vehicle 140 may indicate that the vehicle 140 is entering, exiting, or remaining within a controlled network. Accordingly, an operator of the vehicle 140 may have the option to relinquish control of the vehicle 140 to the network of the system 100, and/or may have the option to maintain user-operated control.

However, in the interests of preserving privacy, the system 100 of other embodiments may instead be a fully independent, standalone system that is unconnected to the Internet. Also, no image or other information need be stored by the system 100 long term. The camera 110 may delete captured images shortly after the information corresponding thereto is transmitted by the local wireless transmitter 150 to the vehicle 140. Accordingly, there need be no significant cost associated with large data storage or with ensuring privacy. Each camera 110 is localized, and the only communication that leaves the relatively small range of the local wireless transmitter 150 (e.g., about a city block) may be a self-diagnostics report, which may go to a substation (e.g., to inform headquarters regarding calibration or repair scheduling)

The system 100 may be designed such that only one agent/intelligent vehicle 140 may access one image stream at a time (e.g., due to the limited range of the short-range local wireless transmitter 150). This may be accomplished by omitting any connection to the Internet or to any other network. Accordingly, the vehicle 140 may be unable to access the data captured by a particular device or system 100 of the present embodiment unless the vehicle 140 is physically within that particular system's 100 wireless range (e.g., within the range of the short-range local wireless transmitter 150).

Accordingly, the system 100 may be unconnected to any physical network, but may still be able to communicate with vehicles and other cameras/systems that are not within the view of the overhead camera 110. For example, the local wireless transmitter 150 connected to the overhead smart camera 110 may have a Wi-Fi range that is much wider than the field of view 130 of a camera lens of the camera 110. Further, when there is one or more desired vehicle-to-vehicle communication connections, the system 100 is able to communicate with other vehicles that might not be within the view of the overhead camera 110.

The system 100 of embodiments of the present disclosure may also achieve privacy in a manner that is similar to GPS technology. All of the information transmitted by the system 100 may be received by the vehicle 140, and the vehicle 140 need not transmit any data. Accordingly, the vehicle 140 may be effectively isolated from the network of the system 100. That is, for example, because the camera 110 that is sensing the vehicle 140 in its field of view 130 may be isolated from the Internet or any other independent systems 100, and because the camera 110 may be privy to only the information corresponding to the objects and vehicles within its field of view 130, privacy may be ensured.

The smart camera 110 may detect objects, such as a car without a QR code, a car with a QR code or with some other identifier, a road, a sign, a pedestrian, or an unidentified object (e.g., an anomaly, or an obstructing object that is worth considering). The system 100 may analyze these various detected objects by using a processor that is part of the system (e.g., a processor that is coupled to the overhead smart camera 110). That is, the system 100 may include a processor to enable it to determine whether a detected object is a vehicle or not, to determine whether a detected object is a normal object that is always present in the field of view 130 of the camera 110 (e.g., a street sign or a stop light), and to determine whether a detected object is not normal/expected.

If the smart camera 110 detects an anomaly in an image captured by the camera 110, the system 100 may provide an indication or other information corresponding to the anomaly. By using vehicle-to-vehicle communications (e.g., between the vehicle 140 and other vehicles in the area), the system 100 may be able to cause all cars in a corresponding lane or area to slow down and to be prepared to stop, including cars that are not within the range of the local wireless transmitter 150. For example, if the overhead smart camera 110 detects a fallen pedestrian (e.g., a girl that fell off of her bicycle), the system 100 may use its processing to determine that the fallen pedestrian is not a vehicle, but is instead an anomaly. The system 100 may then alert the vehicle 140 within the range of the local wireless transmitter 150, which may then alert other vehicles in communication therewith.

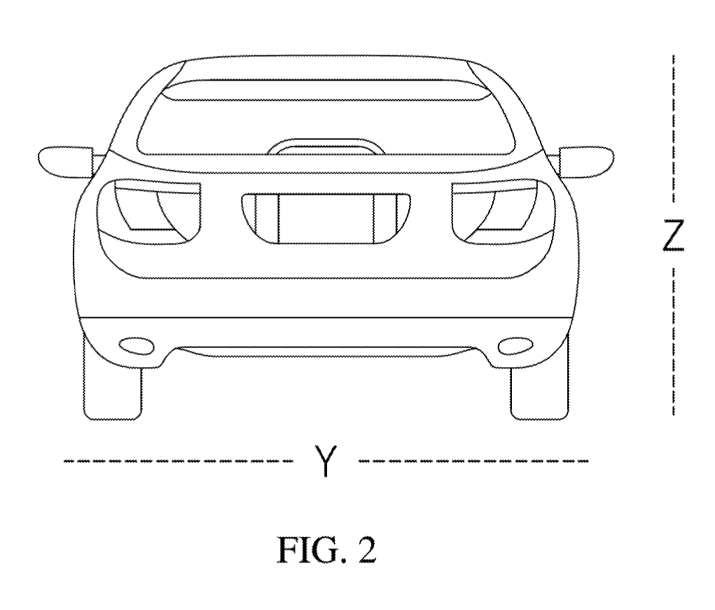

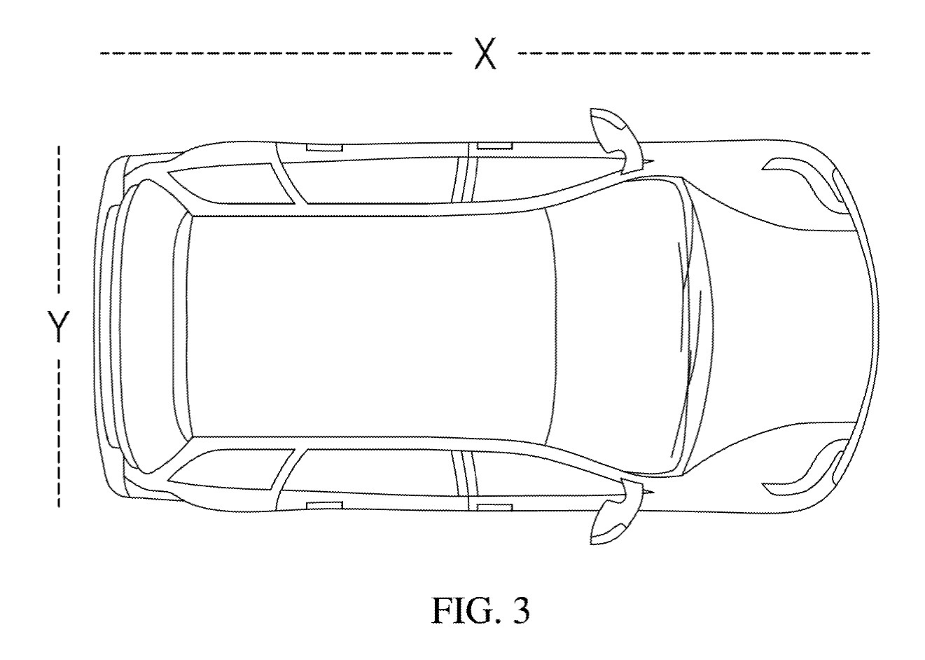

FIG. 2 illustrates Y and Z axes along a vehicle, according to an embodiment of the present disclosure, and FIG. 3 illustrates X and Y axes along a vehicle, according to an embodiment of the present disclosure.

Referring to FIGS. 2 and 3, embodiments of the system 100 described above enable transverse measurement. The infrastructure provided by the system 100 includes one or more cameras that are transverse to both latitude and longitude coordinates, which is in contrast to forward-facing cameras that are only transverse to the vehicles lateral coordinate.

That is, the field of view 130 of the camera 110 is transverse to the global coordinate system. A passing vehicle 140 can subscribe to images and calibration data broadcast by the wireless transmitter 150, and may use information contained within the images to locate or identify itself within the field of view 130. The precise location of the vehicle 140 may then be inferred from the image and calibration data. Accordingly, measurements captured from a perspective of the overhead camera 110 of the present embodiment may be interpreted geometrically. If the vehicle 140 includes one or more onboard cameras and/or a light detection and radar (LiDAR) system, the point of view of the overhead camera 110 is different from the point of view of the cameras of the vehicle 140. That is, the plane view of the overhead smart camera 110 is different from the plane view of the cameras and/or LiDAR of the vehicle 140.

In the present embodiment, included is an example of a vehicle-centered, three-dimensional coordinate system having orthogonal coordinates. In the present example, the X-axis and the Y-axis define a plane that is tangent to the global coordinate system, with the X-axis being collinear with the heading of the vehicle 140 (e.g., the X-axis may be parallel to a direction in which the vehicle 140 is traveling). Accordingly, in the present example, the Z-axis is normal to the global coordinate system.

An onboard camera or LiDAR system of the vehicle 140 may detect another vehicle ahead of it, wherein the Z-axis indicates a vertical direction, and the Y-axis indicates a left-to-right direction (e.g., a direction that is perpendicular to the vehicle's direction of travel). Although navigation of the vehicle 140 may be achieved by relatively precise estimation of the location/coordinates of the vehicle 140 in the X-Y plane, a forward facing camera located on the vehicle 140 may only capture images in the Y-Z plane. Accordingly, an onboard camera may require depth estimation to make measurements along the X-axis (e.g., see FIG. 3). Unfortunately, converting LiDAR sensors and/or an onboard camera of the vehicle into a range finder (e.g., to determine distances along the X-axis) may be relatively difficult and expensive.

The system 100 of the present embodiment with an overhead smart camera 110 is able to provide a bird's-eye view to provide better perception of respective distances from the vehicle 140 to surrounding objects (e.g., in a direction corresponding to the X-axis and/or the Y-axis). That is, the overhead camera 110 enables direct measurement in the X-Y plane, thereby eliminating the need for depth estimation by the onboard sensors of the vehicle 140 along the X-axis, and enabling direct localization measurements. This converts a three-dimensional problem with respect to positioning and localization into a two-dimensional problem. Accordingly, the system 100 is able to provide X-axis information (a direction from front to back of the vehicle 140) to the vehicle 140, and may indicate a distance to a next or previous vehicle.

By combining images captured by an onboard camera of the vehicle 140 with corresponding images captured by the overhead camera 110, the vehicle 140 is able to have a complete three-dimensional view of its surroundings. If the vehicle 140 is an autonomous vehicle having forward-facing cameras for capturing images of the environment in front of the vehicle 140, then the vehicle 140 may be provided with information looking in two directions (e.g., information corresponding to two orthogonal planes).

Accordingly, the vehicle 140 may receive an image captured by the camera 110 and transmitted by the local wireless transmitter 150. The image may indicate localization information corresponding to the vehicle 140 (e.g., speed, direction, position, and/or elevation of the vehicle 140). In one embodiment, such localization information may be used to modify/correct or verify GPS localization of the vehicle 140 by feeding back the localization information to the vehicle's GPS system. For example, a geographic or traffic smart device application may be enabled to collaborate with the system 100 to correct or otherwise improve localization information. The system 100 may further include an application, or a plug-in, to determine localization with or without autonomous driving.

Further, a grid comprising multiple interconnected systems 100 of the present embodiment can work with a smart device to give exact GPS localization and guidance (e.g., to bicyclists and pedestrians). This may include inside structures where GPS may fail (e.g., inside parking garages). Accordingly, a grid of multiple networked systems 100 can provide information indicating the location of empty parking spaces, exact localization, and guidance. In one embodiment, the information transmitted to the vehicle 140 may include a warning to alert the driver when the vehicle is entering, is leaving, or is within, a smart grid including multiple networked systems 100. When entering or within the grid, the driver of the vehicle 140 may decide if they want to allow the smart grid to control the vehicle 140.

As the number of drive-by-wire capable cars increases, the capabilities of the system 100 will likewise increase, along with the safety benefits provided thereby. For example, an autonomous vehicle may have reasonably good ADAS level-2.5 or level-3 abilities, meaning that the vehicle is not capable of driving completely independently, as the vehicle does not have the same capabilities as an expensive level-5 (i.e., fully autonomous) vehicle. However, by providing the vehicle 140 with speed, distance, and localization information within a certain degree of accuracy (e.g., less than a centimeter), the system 100 may effectively increase the capabilities of a level-3 vehicle 140 to those of a full autonomous level-5 vehicle. That is, because the overhead camera 110 is able to indicate that the vehicle 140 is located in a particular lane in accordance with a global coordinate system, the present system 100 may assist even a level-2.5 or level-3 vehicle 140 with driving.

For example, conventional, lower-level autonomous vehicles consider a reaction time of the human driver. Accordingly, such cars should be spaced from each other by a distance that may be determined by the speed of traffic (e.g., by several car links). Additionally, such autonomous cars may take into consideration the effect of potential distractions and the fact that some drivers have a slower reaction time.

However, by using the system 100 of the present embodiment in conjunction with autonomous driving, efficient and effective autonomous driving (e.g., level-5 ability) may be achieved without the expenses generally associated with fully autonomous level-5 vehicles. The system 100 enables intelligent vehicles that receive information from the system to achieve the same level of safety by effectively having the same extremely quick reaction time (e.g., on the order of msec). Accordingly, vehicles used in conjunction with the system 100 can safely travel in much closer proximity to each other, thereby allowing a greater number of vehicles in each lane, thus reducing traffic congestion and gridlock.

As an example, for a low level (e.g., level-2) autonomous vehicle, the system 100 may provide driving instructions, road information, parking information, road construction information, lane-keeping assistance, braking assistance, and safe distancing from objects, pedestrians, and/or other vehicles. For level-3 and level-4 autonomous vehicles, the system 100 may provide driving instructions when the vehicle 140 is located anywhere within the effective area of the system 100 to enable ease of navigation of intersections, roundabouts, stoplights, and road construction. In addition, the system 100 may provide parking information (e.g., the closest open parking space), and may control the vehicle 140 to place it directly in the center of the parking space by providing a bird's-eye view of parking space, and by assessing the location of the vehicle 140 within the park space. For fully autonomous, level-5 vehicles, the vehicle 140 may pilot itself to drop off a user and pick up a user.

FIG. 4 illustrates a calibration vehicle for calibrating a position of an overhead sensor in a global coordinate system, according to one embodiment.

Referring to FIG. 4, when the camera 110 is first installed, the system 100 may calibrate the camera 110 for consistency within the global coordinate system. A calibration vehicle 440 with high level precise positioning equipment can be used to drive under the camera 110, and may transmit to the system 100 positioning information during calibration. The positioning information can be stored in the camera 110 or at the server or substation used to network a grid of cameras 110. Replacement cameras may receive information regarding their positioning from the substation, thereby reducing the need for continuous calibration. The calibration vehicle 440 may have positioning marks 450 on the top of the calibration vehicle 440 that the substation is able to perceive and target via images captured by the camera 110. The substation may then align the camera 110 to within a particular distance (e.g., one centimeter) within the global coordinate system.

As described above, systems of embodiments of the present disclosure provide one or more overhead cameras or sensors that are fixed to respective objects associated with infrastructure associated with vehicle travel (e.g., city or municipal infrastructure, such as light posts/street lamps, stop lights, etc., or private infrastructure, such as buildings and parking structures). Because the direction of the field of view of sensors is highly transverse to the plane corresponding to movement of traffic (e.g., a plane on which an autonomous or driver-assistance enabled vehicle may attempt to localize itself) values associated with localization of the vehicle may be captured by the sensors to be measured directly by processing of the system. Thereafter, the system may broadcast information captured by the sensors (e.g., images, a video stream, calibration data, localization data, speed, acceleration, relative movement, etc.) using a local wireless network, thereby enabling the vehicle to receive such information to assist with decision-making guiding control of the vehicle.

As previously mentioned, a challenge associated with autonomous driving and ADAS is precise localization of a vehicle in a fixed coordinate frame. The system of the embodiments disclosed herein provides infrastructure to compliment the task of precision localization to thereby enable many of the desirable features of ADAS.

Further, an issue that may arise with sensor equipped infrastructure is the privacy of users of the road network. The system of the disclosed embodiments, however, is able to preserve the privacy of road users by using unique identifiers, and by lacking the need to be connected to a network.

Accordingly, the system of the disclosed embodiments may enable “level-5” driving for a vehicle. In short, one large, level-5 autonomous driving ability for the city, and cars with the minimum requirement needed for the city to drive their cars autonomously. This may enable vehicles to safely travel in much closer proximity, may allow vehicles to stop less by matching their timing with the timing on traffic lights, may reduce traffic incidences (e.g., due to distractions or anomalies such as pedestrians, bicycles, etc.), and may make it easier to find parking, may provide quicker access to turning lanes, turn circles, lane changing, etc. The embodiments described herein, therefore, provide improvements to technology related to autonomous driving and driver-assisted control.

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting. Additionally, as those skilled in the art would realize, the described embodiments may be modified in various different ways, all without departing from the spirit or scope of the present disclosure.

In the description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” when preceding a list of elements, modify the entire list of elements and do not modify the individual elements of the list. For example, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise for example indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A system for providing precision localization for intelligent vehicles, the system comprising:
a sensor facing downward to capture information corresponding to an intelligent vehicle below, and in a field of view of, the sensor; and
a transmitter for transmitting the information captured by the sensor to the intelligent vehicle to enable the vehicle to take an action based on the information.

2. The system of claim 1, wherein the sensor is a camera affixed to a light pole.

3. The system of claim 2, wherein the information is a photographic image or video stream including the intelligent vehicle therein.

4. The system of claim 1, wherein the information indicates position, heading, speed, and acceleration of various objects and/or individuals within the field of view of the sensor.

5. The system of claim 1, wherein the transmitter comprises at least one GaN narrow-band laser that is configured to have an intensity or wavelength of light thereof modulated to transmit the information to at least one photodiode of the intelligent vehicle, and
wherein the at least one GaN narrow-band laser is configured to illuminate the field of view of the sensor.

6. The system of claim 1, wherein the information transmitted by the transmitter is configured to be received by a server or substation that is networked to a plurality of transmitters to form a network a plurality of sensors with overlapping fields of view and respectively connected to the plurality of transmitters.

7. The system of claim 6, wherein a position of each of the plurality of sensors and a direction of each corresponding field of view are calibrated to generate a global coordinate system that can be interpreted by the intelligent vehicle.

8. The system of claim 1, wherein the sensor is configured to detect a unique identifier that is attached to the intelligent vehicle, and
wherein the system is configured to encrypt the information based on the identifier such that the intelligent vehicle can receive and decrypt the transmitted information to the exclusion of others.

9. The system of claim 8, wherein the unique identifier is a QR code.

10. A method of providing precision localization for intelligent vehicles, the method comprising:
capturing, by a sensor, information corresponding to an intelligent vehicle below, and in a field of view of, the sensor; and
transmitting the information to the intelligent vehicle to enable the vehicle to take an action based on the information.

11. The method of claim 10, further comprising affixing the sensor to a light pole,
wherein the sensor is a camera, and
wherein capturing information corresponding to the intelligent vehicle comprises capturing a photographic image or video stream including the intelligent vehicle therein.

12. The method of claim 10, wherein the information indicates position, heading, speed, and acceleration of various objects and/or individuals within the field of view of the sensor.

13. The method of claim 10, further comprising illuminating the field of view of the sensor with at least one GaN narrow-band laser,
wherein transmitting the information comprises modulating an intensity or wavelength of light of the at least one GaN narrow-band laser to transmit the information to at least one photodiode of the intelligent vehicle.

14. The method of claim 10, further comprising transmitting the information to a server or substation that is networked to a plurality of transmitters to form a network a plurality of sensors with overlapping fields of view and respectively connected to the plurality of transmitters.

15. The method of claim 14, further comprising calibrating a position of each of the plurality of sensors and a direction of each corresponding field of view to generate a global coordinate system that can be interpreted by the intelligent vehicle.

16. The method of claim 10, further comprising detecting, by the sensor, a unique identifier that is attached to the intelligent vehicle, and
encrypting the information based on the identifier such that the intelligent vehicle can receive and decrypt the transmitted information to the exclusion of others.

17. A non-transitory computer readable medium implemented on a system comprising a sensor facing downward to capture information corresponding to an intelligent vehicle below, and in a field of view of, the sensor, and a transmitter for transmitting the information captured by the sensor to the intelligent vehicle, the non-transitory computer readable medium having computer code that, when executed on a processor, implements a method of providing precision localization for the intelligent vehicle, the method comprising:
capturing, by a sensor, information corresponding to an intelligent vehicle below, and in a field of view of, the sensor; and
transmitting the information to the intelligent vehicle to enable the vehicle to take an action based on the information.

18. The non-transitory computer readable medium of claim 17, wherein the instructions, when executed by the processor, further cause the processor to Illuminate the field of view of the sensor with at least one GaN narrow-band laser,
wherein transmitting the information comprises modulating an intensity or wavelength of light of the at least one GaN narrow-band laser to transmit the information to at least one photodiode of the intelligent vehicle.

19. The non-transitory computer readable medium of claim 17, wherein the instructions, when executed by the processor, further cause the processor to:
detect, by the sensor, a unique identifier that is attached to the intelligent vehicle, and
encrypt the information based on the identifier such that the intelligent vehicle can receive and decrypt the transmitted information to the exclusion of others.

20. The non-transitory computer readable medium of claim 17, wherein the instructions, when executed by the processor, further cause the processor to calibrate a position of each of the plurality of sensors and a direction of each corresponding field of view to generate a global coordinate system that can be interpreted by the intelligent vehicle.
